(19) United States
(12) Patent Application Publication
(10) Pub. No.: US 2021/0261072 A1
(43) Pub. Date: Aug. 26, 2021

(54) POWER CABLE ROUTING FOR A MOTOR CASE

(71) Applicant: Caterpillar Inc., Peoria, IL (US)

(72) Inventors: Randy D. STOECKER, Chillicothe, IL (US); Brian KRUG, Eureka, IL (US); Lance M. COWPER, Metamora, IL (US); Gregory AUSTIN, Peoria, IL (US); Joshua HICKE, Glasford, IL (US)

(73) Assignee: Caterpillar Inc., Peoria, IL (US)

(21) Appl. No.: 16/797,168

(22) Filed: Feb. 21, 2020

(51) Int. Cl. B60R 16/02; H01B 7/00; H01B 9/00; H02G 3/04; H02G 3/30; H02K 11/33; H02K 5/04

(52) U.S. Cl. CPC B60R 16/0215; H01B 7/0045; H01B 9/006; H02K 5/04; H02G 3/30; H02K 11/33; H02G 3/04

(57) ABSTRACT

A drive system is disclosed. The drive system may include a motor case, a generator located externally at a first side of the motor case, an inverter located externally at a second side of the motor case, and at least one tube internal to the motor case. The at least one tube may be configured to carry at least one power cable that connects the generator and the inverter.

### TECHNICAL FIELD

The present disclosure relates generally to a machine and, for example, to power cable routing for a motor case of the machine.

### BACKGROUND

A work machine, such as a work machine with ground-engaging tracks, may employ a powertrain that includes a drive system (e.g., a drive system that transfers power to the ground-engaging tracks). The drive system may include a motor case that houses one or more electric motors. In addition, the drive system may include power distribution cables that provide electrical connections between components of the drive system, such as the electric motors, a generator, an inverter, and/or the like. In some instances, it is difficult to route the cables between the various components of the drive system without interfering with other components (e.g., valves) of the drive system, impairing functionality of the work machine (e.g., when the cables are positioned in a manner that reduces a ground clearance of the work machine), and/or causing damage to the cables (e.g., when the cables are positioned in a manner that exposes the cables to damaging temperatures or debris that may be encountered in a work area).

One attempt at a power cables retaining structure is disclosed in U.S. Pat. No. 7,172,042 that issued to Yamaguchi et al. on Feb. 6, 2007 (“the '042 patent”). In particular, the '042 patent discloses a vehicle power cables retaining structure for retaining power cables laid out along an underside of a floor of a hybrid vehicle. The '042 patent states that the power cables connect a power converter disposed outside an engine compartment with a motor disposed inside the engine compartment. In addition, the '042 patent states that the power cables are individually passed through metallic protection pipes under the floor, where the metallic protection pipes are supported from the underside of the floor, and in the engine compartment, the power cables are passed through a flexible protection tube.

While the power cables retaining structure of the '042 patent may provide protection for power cables run under a floor of a hybrid vehicle, the '042 patent does not address several problems related to routing power cables for a work machine. In particular, locating power cables under a floor of a work machine may reduce a ground clearance of the work machine, and thereby impair functionality of the work machine. Moreover, power cables located under a floor of a work machine may be damaged by debris or earth surfaces encountered in a work area. While the metallic protection pipes described in the '042 patent may be suitable for debris encountered by a hybrid vehicle, the debris and earth surfaces encountered by a work machine in a work area have a damaging potential that may surpass the protection provided by the metallic protection pipes.

The drive system of the present disclosure solves one or more of the problems set forth above and/or other problems in the art.

### SUMMARY

According to some implementations, a motor case may include a first tube internal to the motor case, the first tube configured to carry at least one power cable that connects a generator, located externally at a first side of the motor case, and an inverter, located externally at a second side of the motor case; a second tube internal to the motor case, the second tube configured to carry at least one power cable that connects the generator and the inverter; and a third tube internal to the motor case, the third tube configured to carry at least one power cable that connects the generator and the inverter.

According to some implementations, a drive system may include a motor case; a generator located externally at a first side of the motor case; an inverter located externally at a second side of the motor case; and at least one tube internal to the motor case, the at least one tube configured to carry at least one power cable that connects the generator and the inverter.

According to some implementations, a machine may include one or more electric motors disposed internally in a motor case; a generator located externally at a first side of the motor case; an inverter located externally at a second side of the motor case that is opposite the first side of the motor case, the inverter having an electrical connection to the one or more electric motors; and at least one tube internal to the motor case, the at least one tube configured to carry at least one power cable that connects the generator and the inverter.

### BRIEF DESCRIPTION OF THE DRAWINGS

FIG. 1 is a diagram of an example machine that includes a drive system.

FIGS. 2 and 3 are diagrams of an example drive system that may be used with the machine of FIG. 1.

### DETAILED DESCRIPTION

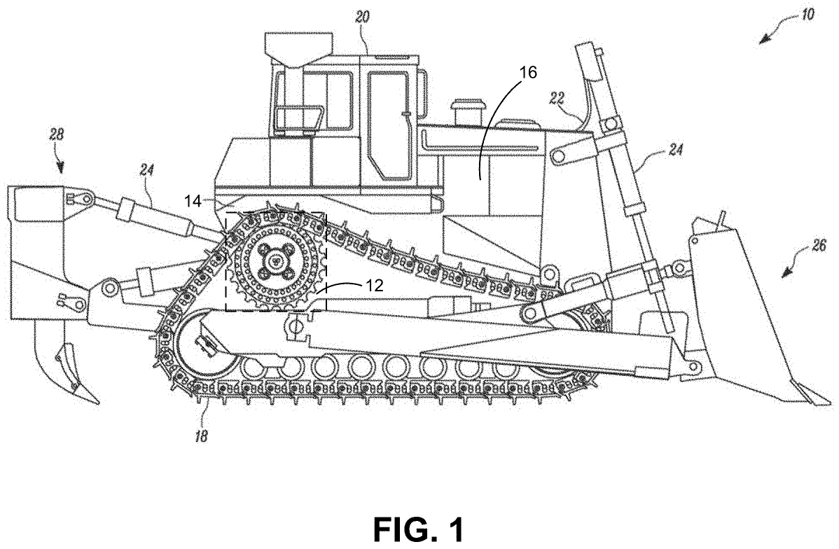

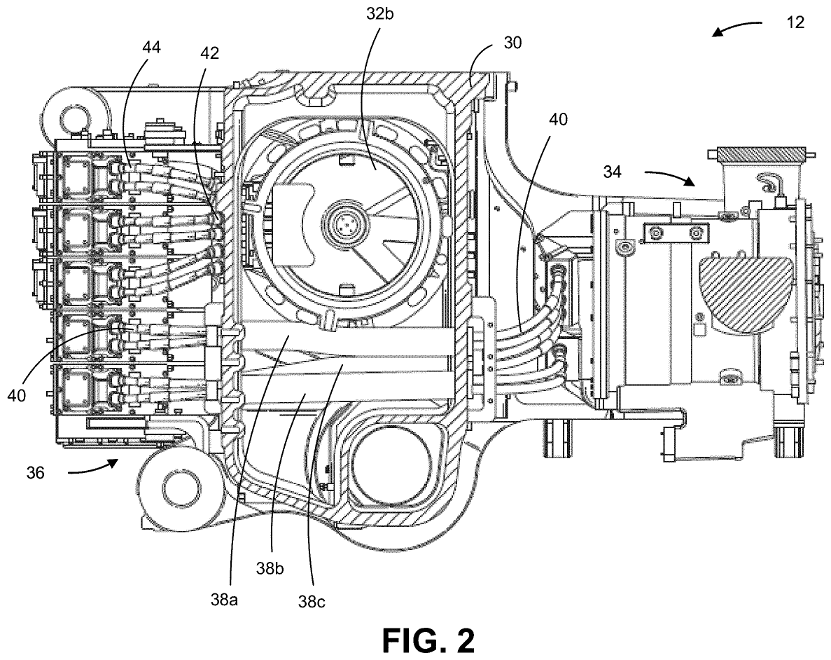

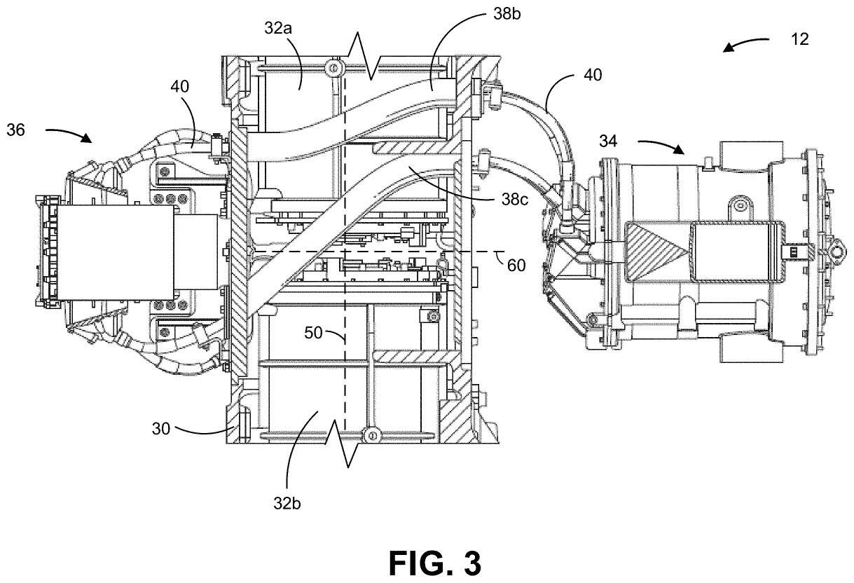

FIG. 1 is a diagram of an example machine 10 that includes a drive system 12 (as described in connection with FIGS. 2 and 3). As shown in FIG. 1, the machine 10 is embodied as a track-type machine, such as a track-type tractor. Alternatively, the machine 10 may be a backhoe loader, a skid steer loader, a wheel loader, a motor grader, an excavator, a scraper, an agricultural tractor, a haul truck, or the like.

As shown in FIG. 1, the machine 10 includes a frame assembly 14 and a power source 16. The power source 16 may include an engine (e.g., a diesel engine) and a generator configured to provide power to the machine 10. For example, the engine and the generator may provide power to one or more electric motors of the machine 10 via a power converter (e.g., an inverter), as described in connection with FIGS. 2 and 3.

The machine 10 also includes a set of ground engaging members 18, such as wheels, tracks, rollers, or the like, for propelling the machine 10. Furthermore, the machine 10 includes an operator cabin 20, which may include one or more input devices (not shown), such as one or more push-buttons, control levers, steering wheels, or the like, for controlling and/or monitoring operations of the machine 10.

The machine 10 may include a hydraulic pump (not shown). The hydraulic pump is operatively coupled to the power source 16 to provide pressurized hydraulic fluid via hoses 22 to hydraulic cylinders 24 for moving tools and implements of the machine 10, such as front attachment 26 and/or a rear attachment 28. The front attachment 26 may include a blade assembly, and/or the like. The rear attachment 28 may include a ripper assembly, a winch assembly, a drawbar assembly, a counterweight assembly, and/or the like.

As indicated above, FIG. 1 is provided as an example. Other examples may differ from what is described in connection with FIG. 1.

FIGS. 2 and 3 are diagrams of an example drive system 12. In particular, FIG. 2 shows a side view of the drive system 12, and FIG. 3 shows a bottom view of the drive system 12. In addition, FIGS. 2 and 3 show cutaway views of a motor case 30 (edges of which, according to the cutaway, are shown by cross-hatching) of the drive system 12 to show internal components of the motor case 30. The motor case 30 is a component of the frame assembly 14 of the machine 10.

The motor case 30 provides a housing for mounting one or more electric motors. For example, a first electric motor 32a (see FIG. 3) and a second electric motor 32b may be disposed internally in the motor case 30. The first electric motor 32a and the second electric motor 32b may be identical electric motors. The first electric motor 32a and the second electric motor 32b may be mounted to opposing sides of the motor case 30, such that the first electric motor 32a and the second electric motor 32b extend toward each other along a common axis 50 (see FIG. 3). In some implementations, the motor case 30 is configured to contain a powertrain fluid (e.g., oil) up to a threshold level. For example, the motor case 30 may be configured to contain the powertrain fluid up to a level that contacts at least one tube 38 (as described below) that is contained in the motor case 30.

The drive system 12 includes a power generator 34 and a power inverter 36 located externally to the motor case 30 (e.g., mounted to the frame assembly 14). The generator 34 generates direct current that is converted to alternating current by the inverter 36 before being supplied to the electric motors 32. In some implementations, the generator 34 and the inverter 36 are located at different sides of the motor case 30.

For example, the generator 34 may be located at a first side of the motor case 30, and the inverter 36 may be located at a second side of the motor case 30. The first side of the motor case 30 and the second side of the motor case 30 may be opposite sides of the motor case 30. For example, the first side of the motor case 30 and the second side of the motor case 30 may be opposite sides of the motor case 30 that are orthogonal to an axis 50 of the electric motors 32. In such a case, the first side of the motor case 30 and the second side of the motor case 30 may be lateral (e.g., horizontal) sides of the motor case relative to a vertical orientation of the motor case 30 (as shown in FIG. 2).

The motor case 30 includes at least one tube 38 (e.g., a first tube 38a, a second tube 38b, and/or a third tube 38c) that is internal to the motor case 30. The tube 38 may extend through a wall of the motor case 30. For example, the tube 38 may have an inlet end that extends through a wall of the first side of the motor case 30 (e.g., at which the generator 34 is located), and an outlet end that extends through a wall of the second side of the motor case 30 (e.g., at which the inverter 36 is located), thereby defining a conduit through the motor case 30. The tube 38 may be welded to the walls at an interior surface and/or an exterior surface of the walls. Additionally, or alternatively, interfaces between the tube 38 and the walls may include gaskets. The tube 38 may be in a fixed position relative to the motor case 30. For example, the tube 38 may be rigid (e.g., non-flexible), such that the tube 38 maintains a position during operation of the machine 10. As an example, the tube 38 may be a metal (e.g., steel) tube.

The tube 38 may be configured to carry at least one power cable 40 (e.g., an electrical cable) that connects the generator 34 and the inverter 36. For example, the tube 38 may be configured to carry two or more power cables 40 that connect the generator 34 and the inverter 36. The tube 38 provides protection to the power cables 40 from fluid (e.g., oil, which can reach a temperature of 90° C.) contained in the motor case 30, as described above. The tube 38 also may be configured to carry air that flows in a direction from the first side of the motor case 30 (e.g., at which the generator 34 is located) to the second side of the motor case 30 (e.g., at which the inverter 36 is located), to thereby provide heat removal (i.e., cooling) for the inverter 36.

In some implementations, the motor case 30 may include a first tube 38a, a second tube 38b, and a third tube 38c. The first tube 38a may be configured to provide a conduit through the motor case 30 (e.g., from the first side to the second side of the motor case 30) that carries at least one power cable 40 (e.g., two power cables 40) that connects the generator 34 to a first side of the inverter 36. The second tube 38b may be configured to provide a conduit through the motor case 30 (e.g., from the first side to the second side of the motor case 30) that carries at least one power cable 40 (e.g., two power cables 40) that connects the generator 34 to the first side of the inverter 36. The third tube 38c may be configured to provide a conduit through the motor case 30 (e.g., from the first side to the second side of the motor case 30) that carries at least one power cable 40 (e.g., two power cables 40) that connects the generator 34 to a second side of the inverter 36. The first side of the inverter 36 and the second side of the inverter 36 may be opposite sides of the inverter 36. For example, the first side of the inverter 36 and the second side of the inverter 36 may be opposite sides of the inverter 36 in a direction of an axis 50 of the electric motors 32.

The first tube 38a and the second tube 38b, which each provide a conduit for a power cable 40 connecting the generator 34 and the first side of the inverter 36, may be vertically stacked (e.g., relative to a vertical orientation of the motor case 30, as shown in FIG. 2) and may be routed through the motor case 30 along corresponding paths (e.g., corresponding horizontal paths). The third tube 38c, which provides a conduit for a power cable 40 connecting the generator 34 and the second side of the inverter 36, may be horizontally spaced (e.g., in a direction of an axis 50 of the electric motors 32) from the first tube 38a and the second tube 38b.

In some implementations, the first tube 38a, the second tube 38b, and the third tube 38c may have inlet ends that are located on the same side of a plane 60 that separates the first electric motor 32a and the second electric motor 32b, and an outlet end of the third tube 38c may be on a different side of the plane 60 than outlet ends of the first tube 38a and the second tube 38b. Accordingly, the inlet end of the third tube 38c and the inlet ends of the first tube 38a and the second tube 38b may have a first horizontal separation (e.g., in a direction of an axis 50 of the electric motors 32), and the outlet end of the third tube 38c and the outlet ends of the first tube 38a and the second tube 38b may have a second horizontal separation that is greater than the first horizontal separation. In other words, the third tube 38c diverges horizontally from the first tube 38a and the second tube 38b from the first side to the second side of the motor case 30. Thus, the outlet ends of the first tube 38a and the second tube 38b may be located at the first side of the inverter 36, and the outlet end of the third tube 38c may be located at the second side of the inverter 36.

A tube 38 may include one or more horizontal bends and/or one or more vertical bends to enable routing of the tube 38, around the electric motors 32, from the first side of the motor case 30 to the second side of the motor case 30. A bend may have a suitable bend radius (e.g., between 400 millimeters (mm) and 500 mm, such as 450 mm), to facilitate insertion and removal of power cables 40 from the tube 38.

The motor case 30 may include at least one cable gland 42 configured to permit an electrical connection between the inverter 36 and the electric motors 32. For example, the motor case 30 may include one or more first cable glands 42 at the first side of the inverter 36 and one or more second cable glands 42 at the second side of the inverter 36. Accordingly, the one or more first cable glands 42 may permit an electrical connection between the inverter 36 and the first electric motor 32a, and the one or more second cable glands 42 may permit an electrical connection between the inverter 36 and the second electric motor 32b.

One or more cable glands 42 may be located in a wall of the motor case 30 (e.g., a wall of the second side of the motor case 30), to thereby permit, through the wall, an electrical connection between the inverter 36 and an electric motor 32. For example, a motor power cable 44, having a first section that is external to the motor case 30 and a second section that is internal to the motor case 30, may connect the inverter 36 and an electric motor 32 via a cable gland 42. That is, the motor power cable 44 may pass through the cable gland 42, such that the cable gland 42 provides a seal (e.g., a fluid-tight seal) around the motor power cable 44.

As indicated above, FIGS. 2 and 3 are provided as examples. Other examples may differ from what is described in connection with FIGS. 2 and 3.

### INDUSTRIAL APPLICABILITY

The disclosed drive system may be used with any machine where improved power cable routing is desired. For example, the drive system may be used with a machine having a generator and an inverter, for powering an electric motor, that are located on different (e.g., opposite) sides of a motor case that houses the electric motor. Typically, the routing of power cables that connect the generator and the inverter in such a configuration may be difficult, may expose the power cables to damage from temperature or debris, and/or may make replacement or servicing of the power cables difficult. According to the disclosed drive system, power cables that connect the generator and the inverter may be routed through the motor case via one or more tubes. In this way, the power cables are protected from damaging temperatures and/or debris. Moreover, the power cables may be easily inserted into the tubes or removed from the tubes (e.g., for installation or servicing) without interference from other cables, cable harnesses, valves, and/or the like, of the drive system.

In addition, the disclosed cable glands facilitate connection between the inverter of the drive system, which is external to the motor case, and one or more electric motors internal to the motor case. This enables easy installation, replacement, or servicing of motor power cables, the electric motors, and/or the inverter, which may otherwise be difficult.

1. A motor case, comprising:
a first tube internal to the motor case,
the first tube configured to carry at least one power cable that connects a generator, located externally at a first side of the motor case, and an inverter, located externally at a second side of the motor case, and
the at least one power cable of the first tube being between the generator and the first side of the motor case and being between the inverter and the second side of the motor case;
a second tube internal to the motor case,
the second tube configured to carry at least one power cable that connects the generator and the inverter; and
a third tube internal to the motor case,
the third tube configured to carry at least one power cable that connects the generator and the inverter.

2. The motor case of claim 1, wherein the first side of the motor case is opposite the second side of the motor case.

3. The motor case of claim 1, wherein the at least one power cable of the first tube connects the generator and a first side of the inverter, the at least one power cable of the second tube connects the generator and the first side of the inverter, and the at least one power cable of the third tube connects the generator and a second side of the inverter.

4. The motor case of claim 1, wherein the at least one power cable of the first tube includes two or more power cables, the at least one power cable of the second tube includes two or more power cables, and the at least one power cable of the third tube includes two or more power cables.

5. The motor case of claim 1, wherein the motor case is configured to contain a fluid.

6. The motor case of claim 1, wherein at least one of the first tube, the second tube, or the third tube are configured to carry air that flows from the first side of the motor case to the second side of the motor case.

7. The motor case of claim 1, further comprising:
at least one cable gland located in a wall of the second side of the motor case,
the at least one cable gland configured to permit an electrical connection between the inverter and one or more electric motors internal to the motor case.

8. A drive system, comprising:
a motor case;
a generator located externally at a first side of the motor case;
an inverter located externally at a second side of the motor case; and
at least one tube internal to the motor case,
the motor case being between the generator and the inverter, and
the at least one tube being configured to carry at least one power cable that connects the generator and the inverter.

9. The drive system of claim 8, wherein the at least one tube includes three tubes.

10. The drive system of claim 9, wherein a first tube is configured to carry at least one power cable that connects the generator and a first side of the inverter, a second tube is configured to carry at least one power cable that connects the generator and the first side of the inverter, and a third tube is configured to carry at least one power cable that connects the generator and a second side of the inverter.

11. The drive system of claim 10, wherein the first side of the inverter is opposite the second side of the inverter.

12. The drive system of claim 8, wherein the motor case is configured to contain oil up to a level that contacts the at least one tube.

13. The drive system of claim 8, wherein the at least one tube is configured to carry air that flows from the first side of the motor case to the second side of the motor case to provide cooling to the inverter.

14. The drive system of claim 8, further comprising:
one or more electric motors internal to the motor case,
wherein the at least one tube is routed around the one or more electric motors.

15. The drive system of claim 8, further comprising:
at least one cable gland located in a wall of the motor case,
the at least one cable gland configured to permit an electrical connection, through the wall, between the inverter and one or more electric motors internal to the motor case.

16. A machine, comprising:
one or more electric motors disposed internally in a motor case;
a generator located externally at a first side of the motor case;
an inverter located externally at a second side of the motor case that is opposite the first side of the motor case,
the inverter having an electrical connection to the one or more electric motors; and
at least one tube internal to the motor case,
the motor case being between the generator and the inverter, and
the at least one tube being configured to carry at least one power cable that connects the generator and the inverter.

17. The machine of claim 16, wherein the at least one tube includes three tubes configured to respectively carry at least one power cable.

18. The machine of claim 16, wherein the motor case is configured to contain oil up to a level that contacts the at least one tube.

19. The machine of claim 16, wherein the at least one tube is configured to carry air that flows from the first side of the motor case to the second side of the motor case.

20. The machine of claim 16, further comprising:
a cable gland located in a wall of the second side of the motor case; and
a power cable that connects the inverter and the one or more electric motors, via the cable gland, to provide the electrical connection.
